(19) United States
(12) Patent Application Publication
(10) Pub. No.: US 2008/0259994 A1
(43) Pub. Date: Oct. 23, 2008

(54) Infrared Radiation Temperature Measuring System with Error Source Radiance Optical Filtering System and Method Using the Same

(76) Inventors: Seong-Wan Kim, Kyungsangbook-do (KR); Deok-Hong Kang, Kyungsangbook-do (KR); Ki-Hong Kim, Kyungsangbook-do (KR)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 12/090,937

(22) PCT Filed: Feb. 27, 2006
(86) PCT No.: PCT/KR2006/000681

§ 371 Date: Apr. 21, 2008

(30) Foreign Application Priority Data
Oct. 21, 2005 (KR) 10-2005-0099905

(51) Int. Cl. G01J 5/00

(52) U.S. Cl. 374/130; 374/121

(57) ABSTRACT

Disclosed herein is a system and method for measuring radiation temperature through filtration of optical error sources, which can measure surface temperatures of a heating substance within a heating furnace. The system comprises a front lens to collect infrared rays from a measuring target and from surroundings, a pin hole plate having a pin hole formed therein to allow only the infrared rays emitting from the measuring target area to pass therethrough, a rear lens to convert the infrared rays having passed through the pin hole into horizontal infrared rays, a condenser lens to collect the infrared rays having passed through the rear lens, and a radiation pyrometer to measure a temperature of the infrared rays having passed through the filtering unit. The system possible can ensure accuracy and reliability in temperature measurement, and can provide highly precise combustion control, operation stability, and improvement in quality of products.

### TECHNICAL FIELD

The present invention relates to a system and method for measuring radiation temperature used to determine surface temperatures of a heating substance in preparation for control of a suitable temperature in a heating furnace and for determination of an extraction time of the heating substance in a furnace process of heating the substance in a solid phase.

More particularly, the present invention relates to a system and method for measuring radiation temperature through filtration of optical error sources, which can effectively block optical error sources affecting measurement of surface temperatures of a heating substance in a heating furnace to cause inaccurate measurement results, thereby achieving accurate measurement of the temperatures of the substance.

### BACKGROUND ART

A conventional technique will hereinafter be described with reference to the accompanying drawings.

FIG. 1 is an explanatory view analyzing error sources in the event of using a conventional radiation temperature measuring system 100. Specifically, a measuring target 110 is generally heated in a heating furnace 105 by a direct fired heating manner, during which various error sources are generated when measuring the temperature of the measuring target 110 by use of the conventional system 100.

The conventional radiation temperature measuring system 100 is a system which mainly absorbs infrared rays emitting from the measuring target area 110 as a heating substance and provides the temperature of the measuring target 110 through conversion of the infrared rays. Meanwhile, the system 100 is generally applied in practice under circumstances in which infrared rays reflecting or emitting from either high temperature radiators positioned around the measuring target or from flames of the heating furnace 105 also affect a radiation thermometer.

Furthermore, the infrared rays from the measuring target area 110 are often absorbed, scattered, and reflected by high temperature combustion gases, such as CO₂ and H₂O, which are filled in the heating furnace 105, and by soot resulting from incomplete combustion. As a result, the infrared rays are affected thereby when entering the conventional system 100, and in some cases, undesired infrared rays also enter the conventional system 100, thereby significantly deteriorating accuracy and reliability of measurement. Accordingly, such a conventional system is rarely used in practice.

FIG. 2 shows the configuration of an error source filtering unit for a conventional radiation temperature measuring system 200, which employs a water cooling type protection pipe 220.

Such a conventional radiation temperature measuring system 200 is disclosed in U.S. Pat. No. 4,093,193, and operated in such a way of filtering unnecessary infrared rays, which emit from surroundings of a measuring target K and enter the system 200, by use of the water cooling type protection pipe 220 inserted into the heating furnace 105. With this temperature measuring system 200, even when the water cooling type protection pipe 220 is installed in the furnace 105, it is difficult to completely block the error sources due to limitation in the length of the protection pipe 220. In addition, the system 200 has a problem in that it cannot block errors caused by intermediate materials acting as emitting media, such as CO₂, H₂O, soot, etc., which are filled in the protection pipe 220.

Furthermore, since it is necessary for the conventional system 200 to have cooling water circulation arrangement for cooling the protection pipe 220, the conventional system 200 has problems in that the number of associated components increases, and in that the protection pipe 220 is likely to be damaged due to local non-uniform cooling.

FIG. 3 shows the configuration of an error source filtering unit for a conventional compensation type radiation temperature measuring system. Such a conventional radiation temperature measuring system shown in FIG. 3 is disclosed in U.S. Pat. No. 4,144,758, and comprises at least two radiation thermometers 300a and 300b for the purpose of preventing background radiation caused by high temperature radiators around the measuring target, in which one of the radiation thermometers is used to measure the temperatures of the measuring target, and the other is used to measure an amount of background radiation to compensate an amount of light reflecting from background radiators.

This system employs a general method for compensating the background radiation from all high temperature radiators around the measuring target 110. Thus, if the background radiators have different temperatures, the conventional system is difficult to achieve complete compensation of the background radiation. Furthermore, since this system employs the at least two radiation thermometers 300a and 300b, it suffers from difficulties in installation, maintenance and repair thereof.

Moreover, as in the system comprising the water cooling type protection pipe 220, the conventional system shown in FIG. 3 also has the problem in that it cannot block the errors sources caused by the intermediate materials acting as the emitting media.

### DISCLOSURE OF INVENTION

### Technical Problem

The present invention has been made to solve the foregoing problems of the prior art, and it is an aspect of the present invention to provide a system and method for measuring radiation temperature through filtration of optical error sources, which can block optical error sources in an effective manner when measuring surface temperatures of a heating substance within a direct fired or indirect fired heating furnace by use of a radiation pyrometer, thereby achieving accurate temperature measurement.

### Technical Solution

In accordance with one aspect of the present invention, the above and other object of the present invention can be achieved by the provision of a radiation temperature measuring system capable of measuring surface temperatures of a measuring target within a direct or indirect fired heating furnace in a non-contact manner while filtering optical error sources in temperature measurement, the system comprising: an error source filtering unit to allow only infrared rays reflecting and emitting from the measuring target area within the heating furnace to pass through the filtering unit; and a radiation pyrometer to measure a temperature of the infrared rays having passed through the filtering unit.

Preferably, the error source filtering unit comprises: a front lens to collect the infrared rays reflecting and emitting from the measuring target area within the heating furnace and infrared rays emitting from a surrounding material and an intermediate material within the heating furnace; a pin hole plate having a pin hole formed therein to allow only the infrared rays emitting from the measuring target area among the infrared rays having passed through the front lens to pass through the pin hole; a rear lens to convert the infrared rays having passed through the pin hole of the pin hole plate into horizontal infrared rays; and a condenser lens to collect the infrared rays having passed through the rear lens.

Preferably, the front lens is made from a material providing a high permeability for the infrared rays in an interest wavelength band of the radiation pyrometer.

In accordance with another aspect of the present invention, a method for measuring radiation temperature of a measuring target through filtration of optical error sources is provided, comprising: admitting passage of only infrared rays having an interest wavelength band emitting from the measuring target area by use of a front lens, a rear lens and a pin hole; and collecting only the infrared rays having the interest wavelength band by use of a condenser lens of a radiation pyrometer to measure the radiation temperature with the error sources filtered.

Preferably, the step of admitting the passage of only the infrared rays of the interest wavelength band by use of the front lens, the rear lens and the pin hole is performed using arrangement in which the front lens, a pin hole plate and the rear lens are sequentially arranged from the measuring target area, and supplies the infrared rays, from which the error sources are removed, to the condenser lens.

Preferably, the measuring target, the front lens, the pin hole plate, the rear lens and the condenser lens are coaxially arranged along a single central axis.

In accordance with yet another aspect of the present invention, a method for measuring radiation temperature of a measuring target through filtration of optical error sources is provided, comprising: collecting horizontal infrared rays reflecting and emitting from the measuring target area or emitting from intermediate materials by use of a front lens to reach a pin hole of a pin hole plate through the front lens; maintaining the horizontal infrared rays by use of a rear lens having the same construction as that of the front lens; collecting the infrared rays having passed through the rear lens by use of a condenser lens; and measuring a temperature of the infrared rays having passed through the condenser lens by use of a radiation pyrometer.

### Advantageous Effects

As apparent from the above description, when measuring the surface temperature of a heating substance within a direct or indirect fired type heating furnace with the system of the invention, it is possible to effectively remove error sources caused by the surroundings within the furnace, thereby ensuring accuracy and reliability in measurement. Thus, since the system of the invention is able to provide an actual temperature of the heating substance, it is possible to provide highly precise combustion control in a heating process, operation stability, and improvement in quality of products.

In addition, the system of the invention can solve problems related to installation, maintenance/repair, and large dimensions of a cooling water pipe when employing the conventional water cooling type protection pipe. Furthermore, since the system of the invention has a simple structure as is compared with the conventional protection pipe, it can be easily mounted in target equipment and reduce manufacturing costs while improving reliability in measurement.

Lastly, the system of the invention can solve all problems caused by absence of temperature information of the heating substance in such a circumstance wherein a radiation temperature measuring system is not used for general heating equipment due to low reliability thereof in the prior art or wherein the temperatures of the heating material are not utilized, even when the conventional radiation temperature measuring system is installed in the equipment.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an explanatory view analyzing major error sources in the event of using a conventional temperature measuring system;

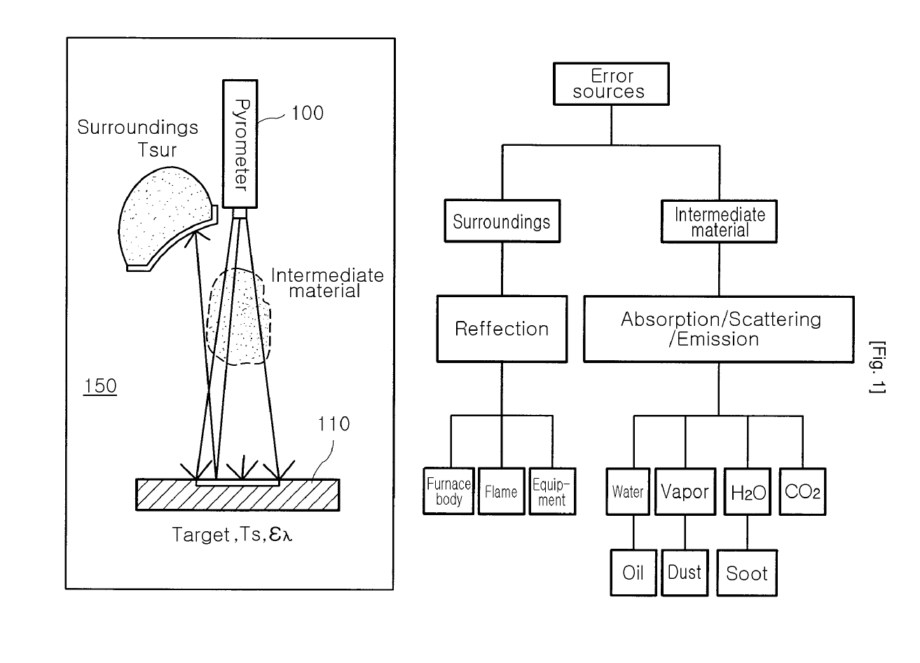

FIG. 2 shows the configuration of a conventional error source filtering unit, which employs a water cooling type protection pipe;

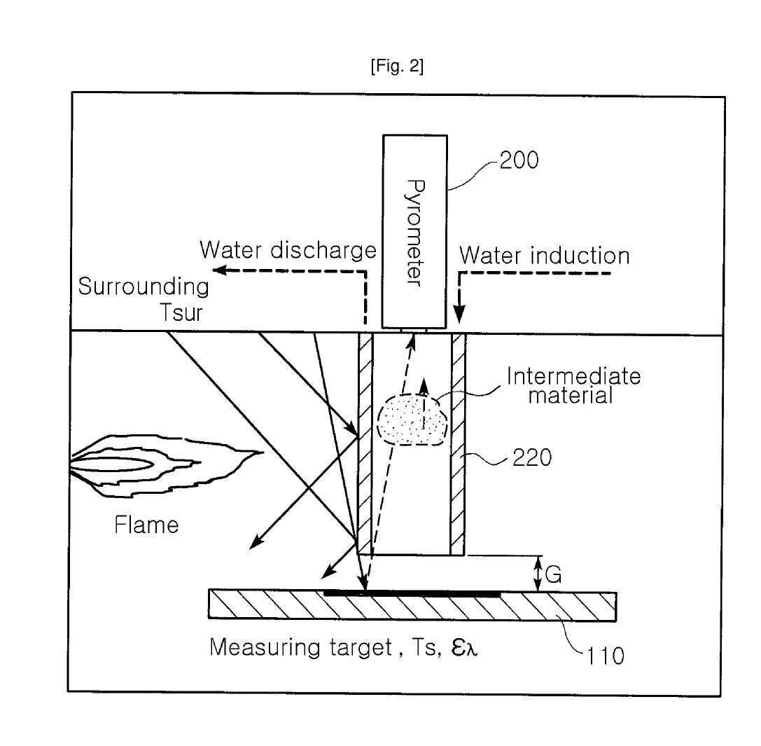

FIG. 3 shows the configuration of another conventional error source filtering unit, which employs a temperature compensation manner;

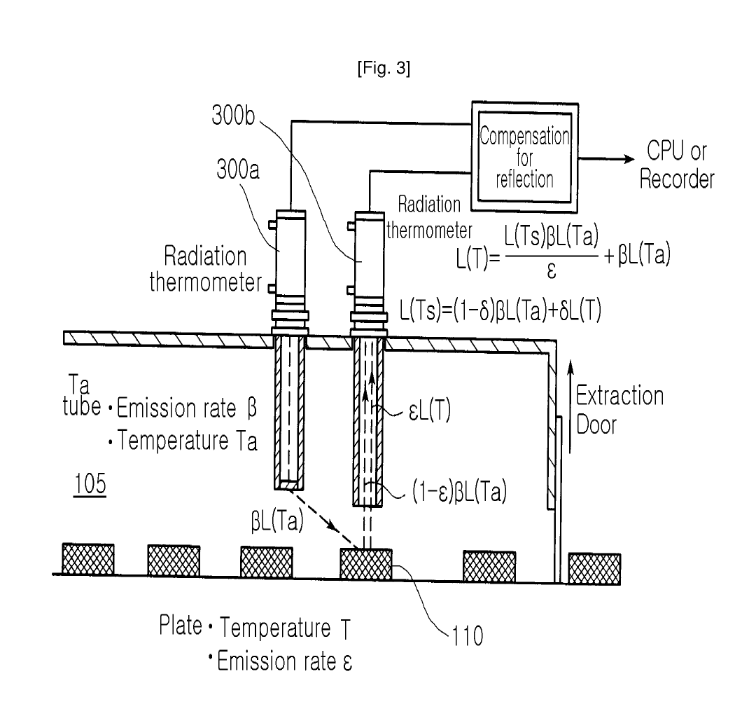

FIGS. 4a and 4b are explanatory views illustrating a principle of a radiation temperature measuring system having an error source filtering function according to the present invention;

FIG. 5 is a view showing an operation of the radiation temperature measuring system with the error source filtering function according to the present invention;

FIG. 6 is a cross-sectional view of the radiation temperature measuring system with the error source filtering function according to the present invention;

FIG. 7 is a diagram showing arrangement of equipment for testing effects of the radiation temperature measuring system having the error source filtering function according to the present invention;

FIGS. 8a and 8b are graphs depicting results of experiments for evaluating % linearity and % bias obtained using the radiation temperature measuring system of the invention and a conventional temperature measuring system, respectively; and

FIGS. 9a and 9b are graphs depicting a sample mean and a sample mean deviation of temperature obtained using the radiation temperature measuring system of the invention and the conventional temperature measuring system, respectively.

### BEST MODE FOR CARRYING OUT THE INVENTION

Exemplary embodiments of the present invention will now be described in detail with reference to the accompanying drawings.

A radiation temperature measuring system 1 with an optical error source filtering function according to the present invention is operated according to a basic principle wherein only a light ray emitting at a desired distance is permitted to reach a radiation pyrometer in preparation for temperature measurement of a measuring target thereby.

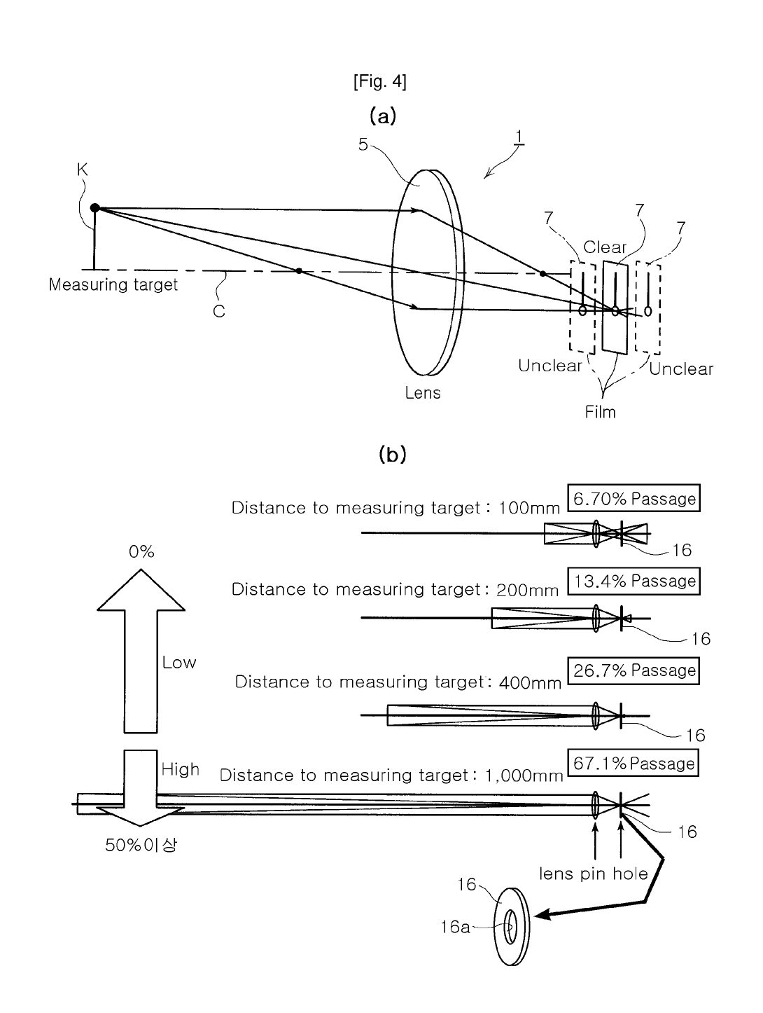

FIG. 4a shows the basic principle for distance selection of the radiation temperature measuring system 1 with the optical error source filtering function according to the invention.

As in a camera, the system 1 allows an image of a measuring target K to be clearly (brightly) focused on a film 7 through suitable adjustment of a focal length of a lens 5, and otherwise unclearly focused thereon when the focal length is not suitably adjusted.

In other words, the system 1 of the invention employs the principle wherein light emitting from the measuring target area K is clearly or unclearly focused on the film 7 depending on accuracy in adjustment of the focal length of the lens 5.

According to the prevent invention, only infrared rays emitting from the measuring target area K positioned at a desired distance are permitted to be mainly selected by use of a pin hole plate and a lens which can provide a high permeability for light in a infrared wavelength band.

In FIG. 4a, reference numeral C indicates a central axis through which light passes and around which lenses are arranged.

FIG. 4b is an explanatory view showing the basic principle for distance selection of the radiation temperature measuring system 1 with the optical error source filtering function according to the invention. As shown in FIG. 4b, it can be appreciated that, when a distance with respect to the measuring target K is changed in the range of 100-1,000 mm with the lens having a focal length of 50 mm and the pin hole plate having a pin hole of 1 mm diameter, an amount of light rays passing through the pin hole plate among light rays emitting from the measuring target area K is changed depending on the distance with respect to the measuring target K.

In other words, if the distance to the measuring target K is 100 mm, 6.70% of infrared rays emitting from the measuring target area K pass through a pin hole 16a of the pin hole plate 16. If the distance to the measuring target K is 200 mm, 13.4% of the infrared rays from the measuring target area K pass through the pin hole 16a of the pin hole plate 16. If the distance to the measuring target K is 400 mm, 26.7% of the infrared rays therefrom pass through the pin hole 16a of the pin hole plate 16, and if the distance to the measuring target K is 1,000 mm, 67.1% of the infrared rays therefrom pass through the pin hole 16a of the pin hole plate 16.

Thus, it can be understood that the amount of light emitting from the measuring target area K and passing through the pin hole are significantly varied depending on the distance with respect to the measuring target K.

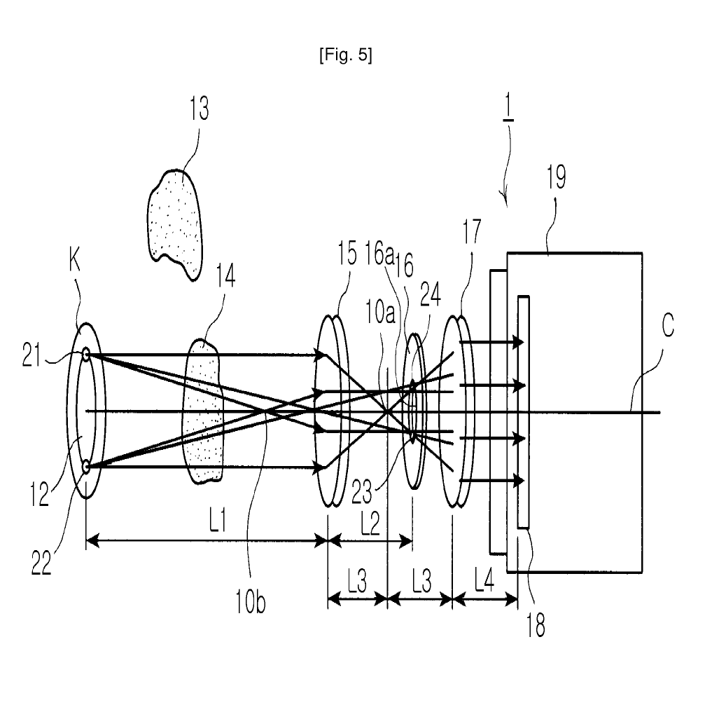

FIG. 5 is a view schematically showing an operation of the radiation temperature measuring system with the error source filtering function according to the invention.

In FIG. 5, a radiation pyrometer 19 is to measure the temperature of a measuring region 12 which is a local region of the measuring target K. In order to achieve accurate measurement, among the infrared rays emitting from the measuring region 12 of the measuring target K, only the infrared rays in an interest wavelength band is permitted to be collected by the condenser lens 18 of the radiation pyrometer 19. However, in this case, there are problems in that infrared rays emitting from a high temperature radiator (or flame) 13 around the measuring target K are after collected by the condenser lenses 18 after reaching the measuring region 12 and then being reflected thereby, and in that undesired infrared rays are also collected by the condenser lens 18 through absorption, scattering and radiation of infrared rays emitting from an intermediate material acting as emitting media positioned or possibly positioned between the radiation pyrometer 19 and the measuring region 12.

Therefore, the radiation pyrometer 19 is deteriorated in accuracy and reliability of measurement due to such problems.

In order to solve the aforementioned problems, the radiation temperature measuring system 1 with the optical error source filtering function according to the present invention comprises a front lens 15, a pin hole plate 16 having a pin hole 16a formed at a center region, and a rear lens 17, which are sequentially arranged along the central axis C between the radiation pyrometer 19 and the measuring region 12 of the measuring target K.

Referring to FIG. 5, with the temperature measuring system 1 of the invention, horizontal infrared rays among infrared rays emitting from a point 21 at an upper portion of the measuring region 12 in the measuring target K are forced to pass through a rear focus 10a of the front lens 15 via the front lens 15, and then pass through a portion 23 of the pin hole 16a in the pin hole plate 16.

In addition, among the infrared rays emitting from the point 21 of the measuring target K, infrared rays passing through a front focus 10b of the front lens 15 are converted into horizontal infrared rays through the front lens 15 and then pass through the portion 23 of the pin hole 16a in the pin hole plate 16, and infrared rays having passed through the central axis of the front lens 15 straightly pass through the portion 23 of the pin hole 16a in the pin hole plate 16.

With this operation, an image of the point 21, which corresponds to a point at the upper portion of the measuring region 12 in the measuring target K, is focused on the portion 23 of the pin hole 16a in the pin hole plate 16.

Similarly, horizontal infrared rays among infrared rays emitting from a point 22 at a lower portion of the measuring region 12 in the measuring target K are forced to pass through a rear focus 10a of the front lens 15 via the front lens 15, and then pass through a portion 24 of the pin hole in the pin hole plate 16.

In addition, among the infrared rays emitting from the point 22 of the measuring target K, infrared rays passing through the front focus 10b of the front lens 15 are converted into horizontal infrared rays through the front lens 15 and then pass through the portion 24 in the pin hole plate 16, and infrared rays having passed through the central axis of the front lens 15 straightly pass through the portion 24 of the pin hole 16a in the pin hole plate 16.

With this operation, an image of the point 22, which corresponds to a portion at the lower portion of the measuring region 12 in the measuring target K, is focused on the portion 24 of the pin hole 16a in the pin hole plate 16.

For the temperature measuring system 1 according to the invention, a rear focal length L3 of the front lens 15 and a diameter of the pin hole 16a in the pin hole plate 16 are determined in consideration of optical and geometrical characteristics depending on a distance L1 between the front lens 15 and the measuring target K in order to allow all the infrared rays emitting from the measuring region 12 of the measuring target K to pass through the pin hole plate 16. In addition, the front lens 15 is made from a material providing a high permeability for the infrared rays in an interest wavelength band of the radiation pyrometer 19.

Preferably, the front lens 15 is made from a single crystal of CaF₂ or MgF₂.

Meanwhile, if the light rays passing through the pin hole plate 16 is directly delivered to the condenser lens 18, there occurs a problem in that large amounts of light rays are diverged to the outside rather than being collected on the condenser lens 18. Thus, in order to increase a light collection efficiency, the rear lens 17 having the same configuration as that of the front lens 15 is symmetrically positioned with respect to the front lens 15 such that the rear lens 17 shares a front focus with the rear focus of the front lens 15, thereby allowing the infrared rays passing through the pin hole plate 16 to be collected on the condenser lens 18 by the rear lens 17.

At this time, a distance L4 between the rear lens 17 and the condenser lens 18 is preferably determined in consideration of the optical and geometrical characteristics to maximize the light collection efficiency.

With the construction as described above, the radiation temperature measuring system 1 according to this invention allows only the infrared rays emitting from the measuring region 12 of the measuring target K to reach the radiation pyrometer 19, thereby eliminating the influence of the radiation media between the measuring target K and the radiation pyrometer 19. In addition, the system of this invention can minimize the size of the measuring region of the measuring target K, thereby minimizing influence by the background reflectors having high temperatures.

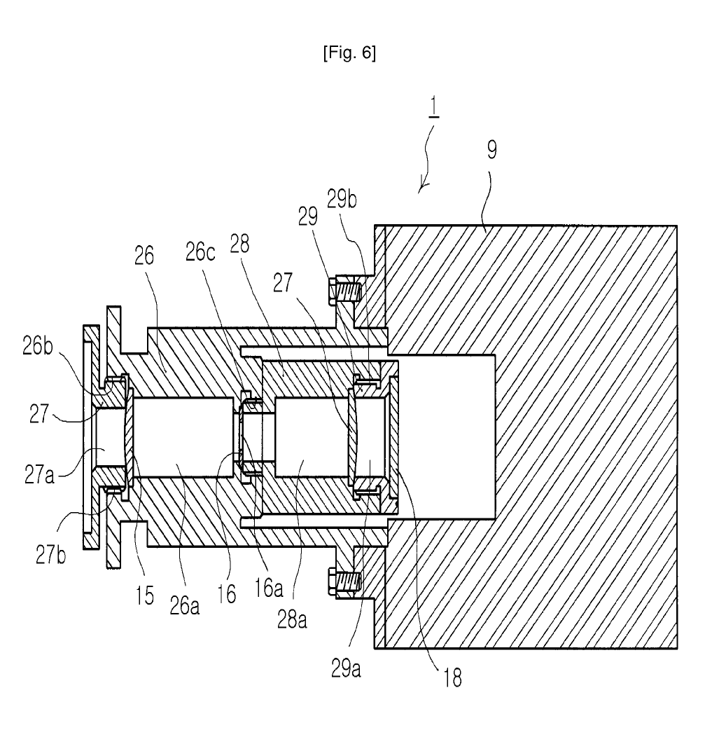

FIG. 6 is a cross-sectional view showing the construction of the radiation temperature measuring system 1 with the error source filtering function according to the present invention.

### Mode for the Invention

The radiation temperature measuring system 1 of the present invention comprises a first hollow case 26 for mounting the front lens 15 therein, which has an optical path 26a defined along the center of the first case 26 and is secured at a rear end to a front side of the radiation pyrometer 19. The first case 26 is provided at a front side with a front lens mounting space, which has a female screw 26b formed therein and is provided with a front securing member 27 engaging with the female screw 26b. The front securing member 27 has an optical path 27a, which is defined along the center thereof and coaxial with the optical path 26a of the first case 26, and a male screw 27b, which is formed on an outer circumferential surface of the rear end thereof and engages with the female screw 26b of the first case 26 to secure the front lens 15 in the first lens mounting space of the first case 26.

In addition, the radiation temperature measuring system 1 of the present invention comprises a second case 28 for mounting the pin hole plate 16 therein, which is coaxial with the first case 26 and screwed into an inner surface of the first case 26. The second case 28 also has an optical path 28a defined along the center thereof, and is screwed into a inner side mounting groove 26c of the first case 26 to secure the pin hole plate 16 in place. Additionally, the second case 28 is provided at a rear end thereof with the rear lens 17.

For this purpose, the second case 28 is formed at the rear end with a rear lens mounting space, which has a female screw 28b formed therein and is provided with a rear securing member 29 engaging with the female screw 28b. The rear securing member 29 has an optical path 29a, which is defined along the center thereof and coaxial with the optical path 28a of the second case 28, and a male screw 29b, which is formed on an outer circumferential surface thereof and engages with the rear side of the second case 28 to secure the rear lens 17 in the mounting space of the second case 28.

Preferably, the rear securing member 29 integrally mounts the condenser lens 18.

In the above construction, the front and rear lenses 15 and 17 are preferably convex lenses, each of which has a flat surface at one side thereof, and are mounted in opposite directions as shown in FIG. 6.

With this construction, the infrared rays emitting from the measuring target area K are input to the system 1 through the optical path 27a of the front securing member 27, and passes through the optical path 26a defined along the center of the first case 26 via the front lens 15.

Then, the infrared rays sequentially pass through the pin hole 16a of the pin hole plate 16, the optical path 28a of the second case 28, and the rear lens 17. Thereafter, the infrared rays reach the radiation pyrometer 19 after passing through the optical path 29a of the rear securing member 29 and the condenser lens 28.

In addition, the present invention provides a method for measuring radiation temperature of a measuring target through filtration of optical error sources. The method of the invention comprises admitting passage of only infrared rays having an interest wavelength band emitting from a region of the measuring target K to pass through a front lens 15, a rear lens 17 and a pin hole 16a, and collecting only the infrared rays of the interest wavelength band by use of a condenser lens 18 of a radiation pyrometer 19 to measure the radiation temperature with the optical error sources filtered.

In the method according to the invention, preferably, the step of admitting the passage of only the infrared rays of the interest wavelength band by use of the front lens 15, rear lens 17 and pin hole 16a is performed using arrangement with the front lens 15, the pin hole plate 16 and the rear lens 17 sequentially arranged from the measuring target area K, and supplies the infrared rays, from which the error sources are removed, to the condenser lens 18.

Additionally, preferably, the measuring target K, front lens 15, pin hole plate 16, rear lens 17 and condenser lens 18 are coaxially arranged along a single central axis C so that the radiation temperature of the measuring target K is measured without any optical error.

Alternatively, according to the invention, the method for measuring radiation temperature of the measuring target through filtration of optical error sources may comprise collecting horizontal infrared rays reflecting and emitting from the measuring target area K or emitting from the intermediate media 13 and 14 by use of the front lens 15 to reach the pin hole 16a of the pin hole plate 16 through the front lens 15, and maintaining the horizontal infrared rays by use of the rear lens 17 which has the same configuration as that of the front lens 15.

The method further comprises collecting the infrared rays having passed through the rear lens 17 by use of the condenser lens 18, and measuring a temperature of the infrared rays having passed through the condenser lens 18 by user of the radiation pyrometer 19.

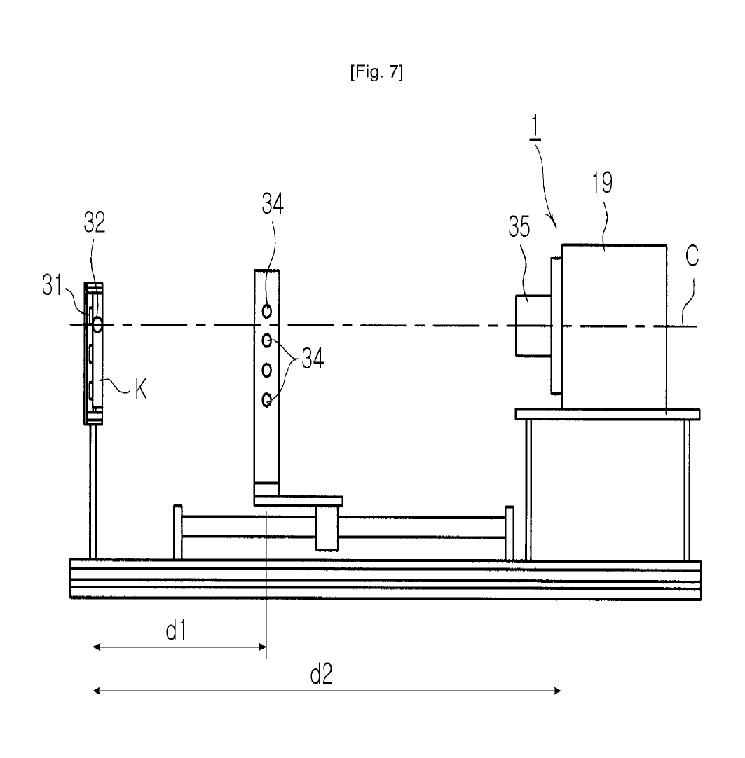

Various experiments were carried out to test and verify error source filtration effects of the radiation temperature measuring system 1 according to the present invention, which can block the optical error sources. FIG. 7 schematically shows arrangement of equipment for testing effects of the radiation temperature measuring system according to the invention.

The equipment was constituted by a radiation pyrometer 19, a filter unit 35 for blocking error sources, a high temperature heat source 34 for generating error sources, a measuring target (sample) K, a thermocouple 32 for measuring the temperature of the sample, and an electric heater 31 for heating the measuring target K.

In the equipment of the invention, a distance dl between the radiation pyrometer 19 and the measuring target K was 1,054 mm, and a distance d2 between the heat source 34 and the measuring target K was 570 mm. The radiation pyrometer 19 was a dual wave radiation pyrometer (available from Williamson, Inc., a diameter of a measuring region: 18 mm, and a distance to the measuring target K: 1 m). The electric heater 31 was designed to heat the sample up to 800° C. at a power of 1.5 □ in a cartridge manner.

Furthermore, the filter unit 35 comprises front and rear lenses 15 and 17, and a pin hole plate 16 disposed therebetween, as shown in FIGS. 5 and 6.

The front and rear lenses 15 and 17 has a focal length of 50 mm. The heating source 34 for generating the error sources comprises two rod-shaped heat sources, which have a diameter of 20 mm, are separated from each other by a distance of 20 mm between the centers thereof, and have a surface temperature maintained at 900° C.

With respect to three cases wherein the measuring target K had temperatures of 580° C., 620° C. and 660° C., the test was carried out to verify the error source filtration effects of the radiation temperature measuring system according to the invention in different conditions wherein the filter unit 35 for blocking the error sources was installed and wherein the filter unit 35 was not installed.

For the test, a sampling speed was set to 0.1 sec, and the temperature of the measuring target K was maintained in an On-Off control manner through feedback of the temperature. The temperature of the measuring target K was obtained as a value of a K-type thermocouple 32 which was positioned at a location within the measuring target K corresponding to a thickness of 20 mm of the measuring target K. With the temperature of the measuring target K stabilized within +5° C. after reaching a target temperature, data was measured and collected.

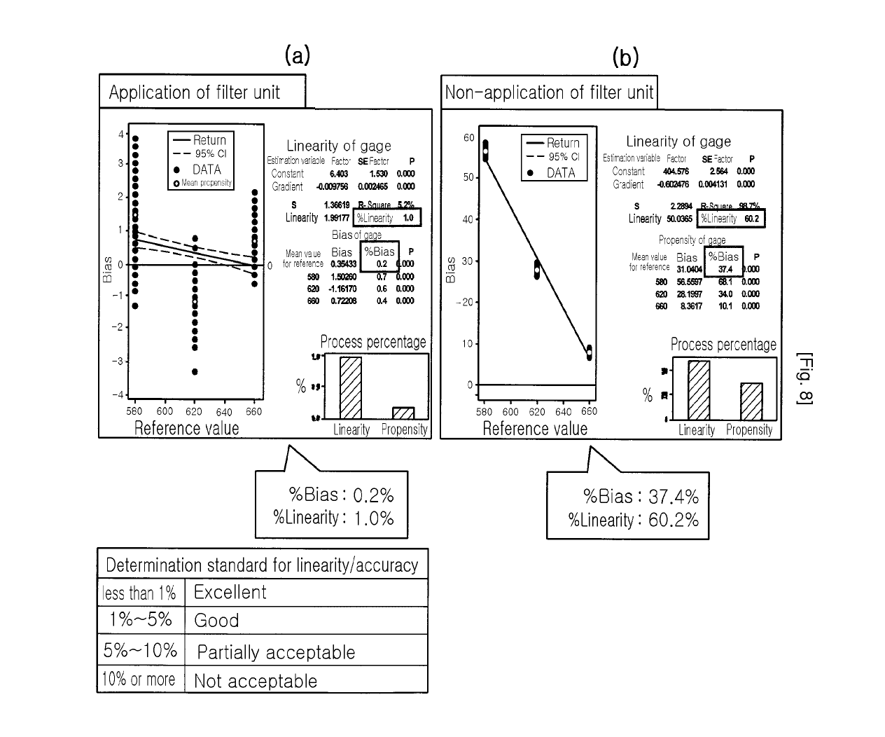

FIGS. 8a and 8b are graphs depicting results of the experiment, and show % linearity and % bias, which can be used for evaluating acceptability of temperature measuring systems depending on whether or not the filter unit 35 of the radiation temperature measuring system 1 is installed therein.

A radiation temperature measuring system wherein the filter unit 35 of the radiation temperature measuring system 1 was not installed, that is, a conventional measuring system, had a linearity of 60.2% and a bias of 37.4%, and thus, it was determined that the conventional measuring system was not acceptable. On the other hand, the radiation temperature measuring system 1 according to the invention comprising the filter unit 35 had a linearity of 1.0% and a bias of 0.2%, and thus, it was determined that the system of the invention was an excellent radiation temperature measuring system.

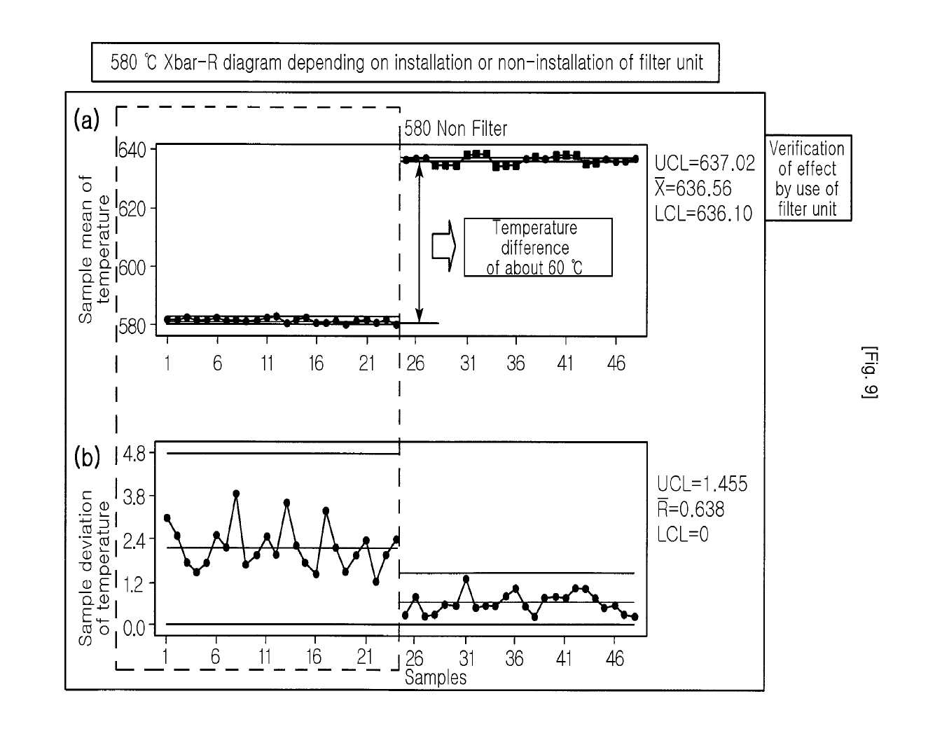

FIGS. 9a and 9b are graphs depicting a sample mean (X) and a sample mean deviation (R) of temperature obtained as results of the test carried out using the radiation temperature measuring system of the invention and the conventional temperature measuring system, respectively, in which a measuring target K was set to 580° C. When using the conventional temperature measuring system which did not comprise the filter unit 35 of the invention, many temperature data were erroneous values, which were deviated from the sample mean, and is thus low in reliability. Furthermore, since the temperature data of the conventional system were about 60° C. higher than those of the present invention when comparing with the radiation temperature measuring system which had the filter unit 35, it could be concluded that the temperature data of the conventional system were incorrect.

Table 1 shows effects depending on use of the filter unit 35 which is included in the radiation temperature measuring system 1 of the present invention.

TABLE 1
Precision and accuracy in temperature measurement depending
on use of filter unit

Multi-wave pyrometer

| | | Non-filter unit | Filter unit |
|---|---|---|---|
| Precision | % Bias | 37.4% | 0.2% |
| | % Linearity | 60.2% | 1.0% |
| Accuracy | 580.0° C. | 56.56° C. | 1.503° C. |
| | 620.0° C. | 28.2° C. | −1.162° C. |
| | 660.0° C. | 660.6° C. | 0.722° C. |

As can be seen from Table 1, when using the conventional measuring system not comprising the filter unit 35, both % linearity and % propensity are 10% or more, which means that the conventional measuring system cannot be applied in practice. On the other hand, when using the system of the present invention comprising the filter unit 35, both % linearity and % bias are 1% or less, which means that the system of the invention can be applied in practice.

In addition, since the system of the invention provided a temperature deviation of 2.0° C. or less in terms of measurement accuracy for all cases of sample temperatures of 580° C., 620° C. and 660° C., the error source filtering effects by use of the filter unit 35 could be verified.

As such, according to the invention, it can be verified that the filter unit provides the error source filtering effects in the radiation temperature measuring system.

### INDUSTRIAL APPLICABILITY

Since the radiation temperature measuring system of the present invention can inform an actual temperature of a heating substance, it is possible to provide highly precise combustion control in a heating process, operation stability, and improvement in quality of products.

In addition, since the system of the invention has a simple structure, it can be easily mounted in target equipment and reduce manufacturing costs while improving reliability in measurement.

While the present invention has been shown and described in connection with the embodiments, it should be noted that these embodiments are provided for the illustrative purpose without limiting the scope of the present invention to specific structure. It will be apparent to those skilled in the art that modifications and variations can be made without departing from the spirit and scope of the invention as defined by the appended claims. However, it should be noted that these modification and variations are included in the scope of the present invention.

1. A radiation temperature measuring system capable of measuring surface temperatures of a measuring target within a direct or indirect fired heating furnace in a non-contact manner while filtering optical error sources in temperature measurement, the system comprising:
an error source filtering unit to allow only infrared rays reflecting and emitting from the measuring target area within the heating furnace to pass through the filtering unit; and
a radiation pyrometer to measure a temperature of the infrared rays having passed through the filtering unit.

2. The system according to claim 1, wherein the error source filtering unit comprises:
a front lens to collect the infrared rays reflecting and emitting from the measuring target area within the heating furnace and infrared rays emitting from a surrounding material and an intermediate material within the heating furnace;
a pin hole plate having a pin hole formed therein to allow only the infrared rays emitting from the measuring target area among the infrared rays having passed through the front lens to pass through the pin hole;
a rear lens to convert the infrared rays having passed through the pin hole of the pin hole plate into horizontal infrared rays; and
a condenser lens to collect the infrared rays having passed through the rear lens.

3. The system according to claim 2, wherein the front lens is made from a material providing a high permeability for the infrared rays in an interest wavelength band of the radiation pyrometer.

4. The system according to claim 3, wherein the front lens is made from a single crystal of CaF₂ or MgF₂.

5. The system according to claim 2, wherein the front and rear lenses have the same focal length.

6. The system according to claim 2, wherein the front and rear lenses have the same optical and physical characteristics.

7. The system according to claim 1, wherein the front and rear lenses are convex lenses, each having a flat surface at one side thereof.

8. A method for measuring radiation temperature of a measuring target through filtration of optical error sources, comprising:
admitting passage of only infrared rays having an interest wavelength band emitting from the measuring target area by use of a front lens, a rear lens and a pin hole; and
collecting only the infrared rays having the interest wavelength band by use of a condenser lens of a radiation pyrometer to measure the radiation temperature with the error sources filtered.

9. The method according to claim 8, wherein the step of admitting the passage of only the infrared rays of the interest wavelength band by use of the front lens, the rear lens and the pin hole is performed using arrangement in which the front lens, a pin hole plate and the rear lens are sequentially arranged from the measuring target area, and supplies the infrared rays, from which the error sources are removed, to the condenser lens.

10. The system according to claim 9, wherein the measuring target, the front lens, the pin hole plate, the rear lens, and the condenser lens are coaxially arranged along a single central axis.

11. A method for measuring radiation temperature of a measuring target through filtration of optical error sources, comprising:
collecting horizontal infrared rays reflecting and emitting from the measuring target area or emitting from intermediate materials by use of a front lens to reach a pin hole of a pin hole plate through the front lens;
maintaining the horizontal infrared rays by use of a rear lens having the same construction as that of the front lens;
collecting the infrared rays having passed through the rear lens by use of a condenser lens; and
measuring a temperature of the infrared rays having passed through the condenser lens by use of a radiation pyrometer.
